(19) United States
(12) Patent Application Publication
(10) Pub. No.: US 2014/0045055 A1
(43) Pub. Date: Feb. 13, 2014

(54) LITHIUM-ALUMINUM BATTERY

(71) Applicants: Hiroshi Nakano, Tokyo (JP); Yoshinori Negishi, Tokyo (JP); Haruo Akahoshi, Tokyo (JP); Katsunori Nishimura, Tokyo (JP)

(72) Inventors: Hiroshi Nakano, Tokyo (JP); Yoshinori Negishi, Tokyo (JP); Haruo Akahoshi, Tokyo (JP); Katsunori Nishimura, Tokyo (JP)

(21) Appl. No.: 14/113,742

(22) PCT Filed: Apr. 25, 2012
(86) PCT No.: PCT/JP2012/061068

§ 371 Date: Oct. 24, 2013

(30) Foreign Application Priority Data
Apr. 26, 2011 (JP) 2011-097738

(51) Int. Cl. H01M 10/0569; H01M 10/0525

(52) U.S. Cl. CPC H01M 10/0569; H01M 10/0525
USPC 429/188; 429/231.95; 429/223

(57) ABSTRACT

A secondary battery capable of charging and discharging includes a positive electrode, a negative electrode, and an electrolytic solution, wherein the negative electrode permits aluminum to deposit thereon and the positive electrode permits lithium to be released therefrom at the time of discharging. The secondary battery excels conventional ones in output density and safety.

### TECHNICAL FIELD

The present invention relates to a secondary battery of high output and enhanced safety.

### BACKGROUND ART

Recent years have seen the widespread consumer use of lithium-ion secondary batteries of rocking chair type in which lithium ions undergo intercalation and deintercalation into and from the positive and negative electrodes. In the automotive and industrial fields, such secondary batteries are required to have a higher output density than before. To this end, investigations are under way to employ lithium metal or alloy for the negative electrode as disclosed in Patent Documents 1 and 2. Unfortunately, lithium metal used for the negative electrode involves a danger of heat generation and combustion in the case of malfunction owing to its high reactivity. Moreover, the reaction on the negative electrode causes the lithium metal to dissolve and deposit in dendroid form, resulting in short circuits between the positive and negative electrodes. This presents difficulties in employing lithium metal for the negative electrode and increasing the battery capacity through the use of lithium metal for the negative electrode.

On the other hand, investigations are going on as to the aluminum-based air battery in expectation for the higher capacity than the lithium-based one because aluminum ions are trivalent whereas lithium ions are monovalent. However, many problems are involved in using aluminum for secondary batteries.

### DOCUMENTS ON PRIOR ARTS

### Patent Documents

Patent Document 1: U.S. Pat. No. 6,482,548
Patent Document 2: JP-4-349365-A
Patent Document 3: JP-2001-243982-A
Patent Document 4: JP-11-317241-A
Patent Document 5: JP-11-283666-A
Patent Document 6: JP-03-238769-A
Patent Document 7: JP-06-052898-A
Patent Document 8: JP-07-272755-A
Patent Document 9: JP-09-120816-A
Patent Document 10: JP-09-259892-A

### SUMMARY OF THE INVENTION

### Problem to be Solved by the Invention

Lithium secondary batteries are required to have a revolutionarily higher output capacity (or energy density) in the future. This object will be achieved at low cost if aluminum can be used for the negative electrode of the battery because aluminum has a theoretical energy density of 2980 mAh/g per unit volume, which is about eight times that of lithium. That is, the battery with a negative electrode of aluminum is highly attractive on account of its high capacity density per unit volume as well as unit weight.

A battery with a negative electrode of aluminum metal or aluminum compound that contains a nonaqueous electrolytic solution works at the time of discharging in such a way that the aluminum metal or compound releases aluminum ions into the electrolytic solution and the released aluminum ions migrate to the positive electrode. At the time of charging, the reaction takes place in the opposite direction and the aluminum ions migrate to the negative electrode (See Patent Documents 6 to 10). For these reactions to take place smoothly, there should exist abundant aluminum ions that migrate through the electrolytic solution. The aluminum ions which have migrated to the positive electrode react with it to form an aluminum compound. This reaction causes corrosion to the positive electrode of aluminum compound owing to its insufficient stability.

In addition, the development of a new electrolytic solution is indispensable for the above-mentioned battery. Unfortunately, it still poses problems to be addressed as follows. That is, an aqueous electrolytic solution is hardly compatible with reversible electrochemical deposition of aluminum because aluminum is by far less prone to reduction than hydrogen from the thermodynamic point of view. Moreover, aluminum has a highly insulating, stable, compact oxide film on its surface on account of its strong affinity with oxygen atoms. This oxide film extremely prevents uniform dissolution of aluminum at the time of discharging, thereby greatly deteriorating the discharge characteristics.

Under these circumstances, there has been proposed (in Patent Document 1) an idea of using, as the electrolytic solution for the primary or secondary battery with the negative electrode of aluminum, a nonaqueous electrolytic solution based on an organic solvent or a nonaqueous electrolytic solution based on ether, which are used for lithium batteries. Moreover, Patent Documents 3, 4, and 5 relating to the improvement of characteristic properties at temperatures between normal temperature and lower temperature of conventional lithium secondary batteries disclose the use of a sulfur-containing compound (such as dimethyl sulfoxide, sulfolane, dimethyl sulfite, and diethyl sulfite) as the electrolytic solution. These electrolytic solutions, however, are not always sufficiently safe because they are composed of combustible solvents. Also, Patent Document 2 discloses a nonaqueous electrolytic solution of salt composed of aluminum halide and N-alkylpyridinium halide or aluminum halide and alkylimidazolium halide, which melts at normal temperature. However, these nonaqueous electrolytic solutions are not always highly stable.

As mentioned above, the aluminum battery is promising because of its high current capacity per unit volume as well as per unit weight, but it poses a problem with operation because of its large self-discharging current which results from corrosion during storage particularly in the case where it employs an aqueous electrolytic solution. By contrast, there is no salt highly capable of dissolving aluminum ions which is to be used as the nonaqueous electrolytic solution. This makes it difficult to realize the aluminum battery capable of discharging with a high current density.

Another problem involved in the aluminum battery is that the positive electrode of aluminum compound suffers corrosion owing to its insufficient stability.

It is an object of the present invention to address the above-mentioned problems and realize a battery based on a nonaqueous electrolytic solution which exhibits good discharging characteristics when used as a primary battery and also exhibits good charging-discharging characteristics when used as a secondary battery.

### Means for Solving the Problem

A secondary battery according to the present invention is capable of charging and discharging, and includes a positive electrode, a negative electrode, and an electrolytic solution, wherein the negative electrode permits aluminum to deposit thereon and the positive electrode permits lithium to be released therefrom at the time of discharging.

### Advantageous Effects of the Invention

The present invention realizes a secondary battery with improved output density, high capacity, and high safety.

### BRIEF DESCRIPTION OF THE DRAWINGS

FIG. 1 is a schematic sectional view of a secondary battery according to the present invention; and

FIG. 2 is a diagram showing a battery system equipped with the batteries according to the present invention.

### DESCRIPTION OF EMBODIMENTS

The following is a description of the embodiment according to the present invention.

The secondary battery according to the present invention includes a positive electrode which occludes and releases lithium ions, a negative electrode which permits aluminum to deposit thereon and dissolve therefrom, and an electrolytic solution which contains the lithium ions. In addition, the positive electrode includes a positive electrode active material, a conductive agent, a binder, and a current collector. The electrolytic solution contains a compound represented by the chemical formula (I) below.

R¹—SO₂—R² (1)

where R¹ and R² denote an alkyl group.

In other words, the positive electrode includes lithium and the negative electrode includes aluminum or aluminum compound. The electrolytic solution contains an electrolytic salt that readily dissolves aluminum ions.

The positive electrode active material may be any one of cobalt oxide, vanadium oxide, manganese oxide, nickel oxide, and iron oxide. They should preferably be used in the lithiated form, such as lithium cobaltate (LiCoO₂), lithium vanadate (LiV₂O₅), lithium manganate (LiMn₂O₄), lithium nickelate (LiNiO₂), and lithium iron phosphate of olivine type (LiFePO₄). Their mixture may be acceptable. A compound containing nickel and manganese is preferable because it raises the positive electrode voltage. Such a compound is represented by the chemical formula LiNiₓMn₂₋ₓO₄ (0.4≦x≦0.6) or the chemical formula LiNiₓQ_{y}Mn_{2-x-y}O₄ (where Q stands for at least one selected from the group consisting of the IIa, IIIa, and IVa groups of the periodic table, transition metals in the fourth period of the periodic table, Zn, Al, Ga, Si, and Ge; 0.4≦x≦0.6 and 0<y≦0.1). The positive electrode active material should preferably be one in which particles with an average diameter of 3 to 20 μm and a maximum diameter no larger than 50 μl account for no less than 90% by volume.

The compound represented by LiNiₓMn₂₋ₓO₄ will pose a problem with the positive electrode increasing in internal resistance in the case where 0.5≧x. The internal resistance can be reduced by incorporating with, as dissimilar element, at least one selected from the group consisting of the IIa, IIIa, and IVa groups of the periodic table, transition metals in the fourth period of the periodic table, Zn, Al, Ga, Si, and Ge.

If the positive electrode active material mentioned above is used in combination with an aluminum negative electrode, the resulting battery has an electromotive force ranging from 1 to 3 V and a positive electrode capacity twice to three times larger than that of a battery provided with a lithium negative electrode. This contributes to the greatly increased capacity.

The positive electrode active material should preferably have corrosion-resistant coating that covers the surface thereof, so that it is saved from crystal disintegration by the electrolytic solution. The corrosion-resistant coating may be formed from aluminum fluoride (AlF₃), a metal oxide such as alumina (Al₂O₃), zirconia (ZrO₂), titania (TiO₂), silica (SiO₂), and aluminum phosphate (Al₂O₃), and a polymeric compound such as polyethylene oxide and pyridine polymer. Any other compounds than mentioned above may be used so long as it saves the positive electrode active material from corrosion by the electrolytic solution.

The binder for the positive electrode may be selected from polytetrafluoroethylene (PTFE), polyethylene fluoride (PVdF), polyacrylic acid or an alkaline salt thereof, and fluororubber. Any other binder than mentioned above may be used so long as it binds together the particles of the positive electrode active material without being affected by the electrolytic solution at the battery's working temperature. The binder should preferably be an elastic one, which is not mandatory. Elastic binders are illustrated by thermosetting resins such as polyimide resin and epoxy resin, which firmly hold the particles of the positive electrode active material.

Since the positive electrode active material is usually formed from a high-resistance material such as oxide, it is desirable to incorporate it with a conductive agent so that the positive electrode increases in electron conductivity. The conductive agent is illustrated by graphite and carbon black (such as acetylene black). The graphite as amorphous carbon should preferably be one characterized by an interlayer distance no smaller than 0.344 nm. The carbon black as amorphous carbon should preferably be one characterized by a specific surface area of 50 to 1000 m²/g.

Carbon black falls under two broad classes according to the manufacturing process: thermal decomposition and incomplete combustion. Either types are acceptable. A preferable type of carbon black is one which is composed of intricately branched and stretched aggregates (as minimum constitutional units). This structure provides a large number of electrical network paths, which leads to improved current collecting performance. The carbon black mentioned above is illustrated by acetylene black and Ketjen black. Additional examples of the conductive agent include amorphous carbon in fibrous form. Examples of the carbon black that can be used in the present invention include gas phase grown carbon fiber produced by pyrolysis, carbon nanotube produced from a carbonaceous material by electric discharge, and carbon fibers produced from pitch by spinning and subsequent carbonization. The fibrous carbon mentioned above is also favorable to the formation of electrical network paths, and hence it contributes to good current collecting performance.

The foregoing is based on experimental results. It has been experimentally shown that graphite (as the conductive agent) having an interlayer distance smaller than 0.344 nm causes anions present in the electrolytic solution to be occluded between its layers when the charging voltage is increased, with the result that the electrolytic solution undergoes decomposition reaction. This is detrimental to the battery's cycle performance, and this explains the reason for graphite being unsuitable. By contrast, it has been experimentally shown that amorphous carbon hardly causes the electrolytic solution to decompose because the occlusion of anions between layers does not take place.

Incidentally, the interlayer distance of carbonaceous material can be determined by X-ray diffraction to be performed on the positive electrode removed from the disassembled battery after discharging.

The positive electrode is provided with a current collector (mentioned above), such as a metal foil having a thickness of 1 to 20 μm. Preferred examples of metal foil are those of stainless steel, nickel, iron, molybdenum, and tungsten. Such metal foils may have a coating of a carbon film, TiN, TiC, or the like.

The positive electrode should include at least the positive electrode active material. The active material may be additionally incorporated with a binder or a conductive agent according to need, so that the positive electrode preferably increases in strength and electron conductivity. Moreover, the positive electrode should preferably have a porous structure which increases the area of contact between the electrolytic solution and the positive electrode active material. This is effective in increasing the output.

The negative electrode should preferably be formed from a foil of aluminum metal or aluminum alloy. A copper foil or nickel foil may also be acceptable if it is provided with aluminum surface coating. Surface coating may be accomplished by binding a powder of aluminum metal or aluminum alloy to the foil surface.

The electrolytic solution should preferably be a molten material composed of an aluminum compound, a lithium compound, and an organic compound. Preferred examples of the organic compound include alkyl sulfone (such as dimethyl sulfone, diethyl sulfone, methyl ethyl sulfone, and dipropyl sulfone) in molten state as a solvent.

The foregoing organic compound as a solvent is nonflammable and solid at normal temperature. Therefore, it is melted by heating so that it functions as the electrolytic solution of the battery. In general, heating is desirable for battery reactions because the heated electrolytic solution improves the ion conductivity and hence lowers the internal resistance. However, this does not hold true of ordinary nonaqueous electrolytic solutions which are flammable polar organic solvents unsuitable for heating.

The electrolytic solution should have an adequate concentration such that 10.0 mol of dimethyl sulfone contains 1.5 to 4.0 mol, particularly 2.0 to 3.0 mol, of aluminum compound. If the content of the aluminum compound is less than 1.5 mol, or if the molar ratio of aluminum compound or aluminum ions to dimethyl sulfone is less than 0.15, the aluminum compound will bring about the decomposition reaction of dimethyl sulfone, thereby forming a black coating film on the surface of the negative electrode. On the other hand, if the content of the aluminum compound is more than 4.0 mol, or if the molar ratio of aluminum compound or aluminum ions to dimethyl sulfone is more than 0.4, the aluminum compound will increase the resistance of the electrolytic solution, thereby causing the negative electrode to suffer uneven reactions for dissolution and depositions. The electrolytic solution should preferably be kept at 65 to 120° C. With a temperature lower than 65° C., the electrolytic solution will have a high viscosity as well as a high resistance. By contrast, with a temperature higher than 120° C., the electrolytic solution will be poor in stability because the aluminum complex existing in the electrolytic solution changes in structure.

Aluminum in the electrolytic solution may be supplied in the form of aluminum salt, such as aluminum halide and organoaluminum compound. Examples of aluminum halide include aluminum chloride anhydride, aluminum bromide anhydride, aluminum perchlorate anhydride, Al(BF₄)₃, Al(PF₆)₂, Al (CF₃SO₃)₃, and Al((C₂F₅SO₂)₂N)₃. The lithium compound to be used for the electrolytic solution is illustrated by lithium perchlorate, lithium chloride, lithium bromide, LiAlCl₄, LiAl₂Cl₇, LiBF₄, LiPF₆, LiClO₄, LiCF₃SO₃, Li (CF₃SO₂)₂N, and Li (C₂F₅SO₂)₂N.

The above-mentioned lithium salt and aluminum salt may be used in combination with an alkali metal salt, such as potassium salt and sodium salt, in a concentration less than 1 mol, so that the electrolytic solution decreases in viscosity. Such alkali metal salts may be in the form of perchlorate, halide, borofluoride (BF₄), phosphofluoride (PF₆), trifluorosulfamide (CF₃SO₃), or ((C₂F₅SO₂)₂N)₃.

The electrolytic solution composed as mentioned above permits two types of ions, aluminum ions (aluminum complex ions, for example) and lithium ions (lithium complex ions, for example), to stably exist in the electrolytic solution all together. This is effective for intercalation and deintercalation of lithium at the positive electrode and also effective for dissolution and deposition of aluminum at the negative electrode. Thus, the battery with the nonaqueous electrolytic solution according to the present invention has a greatly improved capacity and cycle life.

The battery according to the present invention may be encased in a container of various shapes, such as bottomed cylindrical container, bottomed square container, coin-type container, and sheet-like container. Such containers may be metal cans formed from iron, stainless steel, nickel, or the like, with or without insulating internal plastics coating. They may also be formed from laminate film composed of a metal layer and a plastics layer covering one or both sides thereof. The laminate film may range in thickness from 50 to 250 μm. The metal layer may be formed from an aluminum foil ranging in thickness from 10 to 150 μm. The plastics layer may be formed from a thermoplastic resin such as polyethylene and polypropylene. It may be of single-layer type or multi-layer type.

In what follows, the present invention will be described in more detail with reference to Examples, which does not restrict the scope of the invention.

### Example 1

A sample of the electrolytic solution was prepared from dimethyl sulfone (DMS), aluminum chloride anhydride (AlCl₃), and lithium chloride (LiCi), all made by Wako Pure Chemical Industries, Ltd. They were weighed in a glove box conditioned at a dew point of −20° C. and a temperature of 25° C., so that the molar ratio of DMS:AlCl₃:LiCl was 10:3:1. The resulting mixture was heated at 100° C. to give a melt. A sample of the positive electrode was prepared as follows. The active material for the positive electrode was LiNi_{0.4}Mn_{1.6}O₄. This active material was thoroughly mixed with acetylene black as the conductive agent. The resulting mixture was further mixed with polyvinylidene fluoride (PVdF) as a binder, dissolved in N-methyl-2-pyrrolidone (NMP), to give a paste. The positive electrode active material, the conductive agent, and the binder were mixed in a ratio of 90:4:6 by weight. The thus obtained paste was applied onto an aluminum foil as the current collector. With NMP removed by evaporation, the coated aluminum foil was made into the positive electrode by pressure forming. The positive electrode had its surface coated with AlPO₄ in such an amount that the concentration of Al is 5% of the concentration of Mn on the surface.

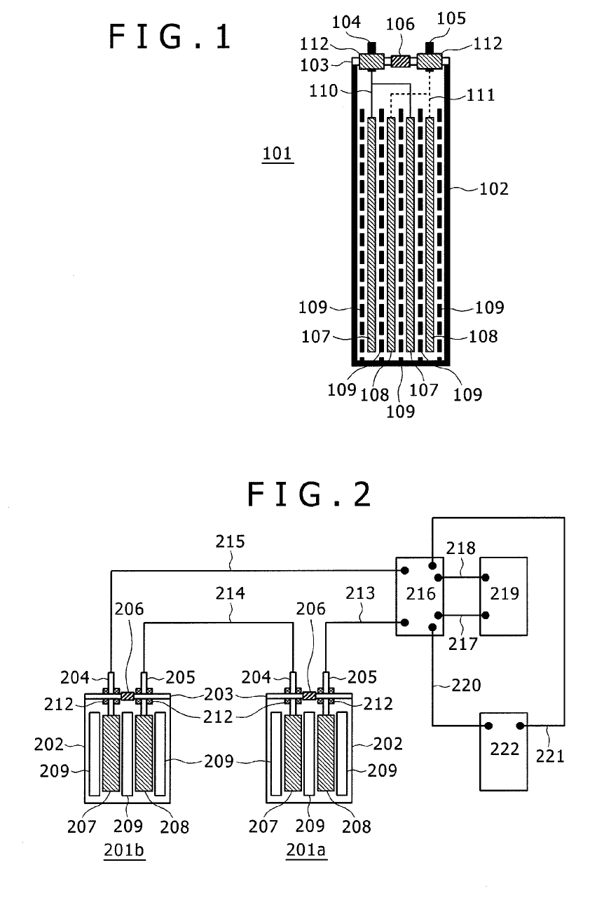

FIG. 1 is a schematic sectional view of a secondary battery according to the present invention. The secondary battery includes the positive electrode, the negative electrode of aluminum metal, and the electrolytic solution, which are mentioned above. It measures 20 mm in diameter and 70 mm in height. The lithium-aluminum secondary battery 101 shown in FIG. 1 has an electrode group consisting of positive electrodes 107, negative electrodes 108, and separators 109 placed between them. The electrode group is sealed and encased in a battery container 102. Each positive and negative electrode has an area of 600 cm².

The battery container 102, which is made of aluminum alloy, with alumina anticorrosive coating thereon, has a lid 103 at the upper part thereof. The lid 103 is provided with a positive electrode external terminal 104, a negative electrode external terminal 105, and an inlet 106 for the electrolytic solution. The lid 103 placed on the battery container 102 is integrally welded at its periphery to the battery container 102 holding the electrodes and separator therein. Attachment of the lid 103 to the battery container 102 may be accomplished by any other method than welding, such as staking and adhesion. The battery container 102 is provided with a heater on its outside to warm the battery prior to start-up. This heater is energized with an external source so as to heat the battery to a temperature (90° C., for example) high enough for the electrolyte to melt, thereby making the battery ready to start.

The lithium-aluminum secondary battery which was prepared as mentioned above underwent constant-current charging and discharging repeatedly in such a way that the working temperature is 90° C., the charge final voltage is 2.3 V, the discharge final voltage is 1.5 V, and the charging-discharging current is 0.5 mA/cm². The foregoing experiment demonstrated that the secondary battery has a high capacity, with the discharge capacity being no lower than 1500 mAh. The same experiment as above mentioned was conducted except that the working temperature was changed to 120° C. The experimental result showed improvement in battery performance, with an increased discharge capacity and battery voltage. Moreover, the tested secondary battery proved itself to be extremely safe on account of its electrolytic solution based on a nonflammable solvent.

After testing, the battery was disassembled to observe the negative and positive electrodes. It was found that the surface of the negative electrode became cloudy but remained uniform without dendroid deposition. It was also found that the surface of the positive electrode retained thereon the active material (black in color), without appreciable change from the initial state.

It was demonstrated by the foregoing experiments that the lithium-aluminum battery according to the present invention functions as a secondary battery excelling in long-term stability and safety because it has the negative electrode which causes aluminum to deposit and the positive electrode which causes lithium to be released at the time of discharging.

The battery demonstrated in this example may also be used as a primary battery if it is supplied to the user in its charged state and the user consumes as much electric energy as delivered by a single cycle of discharging.

### Examples 2 to 10

Table 1 shows results of changing the composition of the electrolytic solution and changing materials of the positive electrode active material and the negative electrode active material. In Examples 2 to 5, variation was made in the composition of the electrolytic solution. In Examples 6 to 10, variation was made in the constituents of the active materials for the positive and negative electrodes. The batteries with nonaqueous electrolytic solution according to Examples 1 to 8 are superior in discharging capacity and life to those according to Comparative Examples 1 and 2 mentioned later.

The secondary battery according to Example 2 is identical with the one according to Example 1 except that dimethyl sulfone for the electrolytic solution is replaced by diethyl sulfone.

The secondary battery according to Example 3 is identical with the one according to Example 1 except that the metal salt for the electrolytic solution is altered.

The secondary battery according to Example 4 is identical with the one according to Example 1 except that potassium chloride is added to the electrolytic solution such that the molar ratio of DMS:AlCl₃:LiCl:KCl=10:3:1:0.1. The resulting electrolytic solution decreased in melting point to 70° C. and also decreased in viscosity.

The secondary battery according to Example 5 is identical with the one according to Example 1 except that the metal salt in the electrolytic solution is altered.

The secondary battery according to each of Examples 6 to 9 is identical with the one according to Example 1 except that the material for the positive electrode is altered.

The secondary battery according to Example 10 is identical with the one according to Example 1 except that the negative electrode is prepared as follows. Firstly, a slurry is made by thoroughly mixing aluminum metal powder having an average particle diameter no larger than 100 μm with water containing polytetrafluoroethylene (PTFE) as a binder dispersed therein. Secondly, the resulting slurry is applied onto a copper foil as a current collector, followed by drying. Lastly, the coated foil is formed into the negative electrode by pressing.

TABLE 1

| | | | Electrolytic solution | | | |
|---|---|---|---|---|---|---|
| | Positive | Negative | Alkyl | | Capacity | Retention |
| | electrode | electrode | sulfone | Electrolyte | (mAh) | of capacity |
| Example 1 | LiNi_{0.4}Mn_{1.6}O₄ | Al foil | Dimethyl | AlCl₃ | 1500 | 85 |
| | | | sulfone | LiCl | | |
| Example 2 | LiNi_{0.4}Mn_{1.6}O₄ | Al foil | Diethyl | AlCl₃ | 1200 | 75 |
| | | | sulfone | LiCl | | |
| Example 3 | LiNi_{0.4}Mn_{1.6}O₄ | Al foil | Dimethyl | Al((C₂F₅SO₂)₂N)₃ | 1700 | 83 |
| | | | sulfone | Li(C₂F₅SO₂)₂N | | |
| Example 4 | LiNi_{0.4}Mn_{1.6}O₄ | Al foil | Dimethyl | AlCl₃ | 1600 | 80 |
| | | | sulfone | LiCl | | |
| | | | | KCl | | |
| Example 5 | LiNi_{0.4}Mn_{1.6}O₄ | Al foil | Dimethyl | LiAl₂Cl₇ | 1550 | 85 |
| | | | sulfone | | | |
| Example 6 | LiCoO₂ | Al foil | Dimethyl | AlCl₃ | 1300 | 85 |
| | | | sulfone | LiCl | | |
| Example 7 | LiNiO₂ | Al foil | Dimethyl | AlCl₃ | 1000 | 75 |
| | | | sulfone | LiCl | | |
| Example 8 | LiMn₂O₄ | Al foil | Dimethyl | AlCl₃ | 1200 | 80 |
| | | | sulfone | LiCl | | |
| Example 9 | LiFePO₄ | Al foil | Dimethyl | AlCl₃ | 1500 | 85 |
| | | | sulfone | LiCl | | |
| Example 10 | LiNi_{0.4}Mn_{1.6}O₄ | Al | Dimethyl | AlCl₃ | 1250 | 72 |
| | | powder | sulfone | LiCl | | |

### Comparative Example 1

The same secondary battery as in Example 1 was prepared except that the negative electrode was made of lithium metal. It produced an output voltage of 4 V, with the initial capacity being 300 mAh, owing to dissolution of lithium metal from the negative electrode and intercalation of lithium ions into the positive electrode during discharging in the initial stage. However, after 15 cycles of charging and discharging, it suffered short circuit because charging brought about deposition of lithium-aluminum compound and deposition of dendroid lithium metal. Thus the comparative sample is superior in initial output voltage but is poor in long-term stability and capacity.

### Comparative Example 2

The same secondary battery as in Example 1 was prepared except that the negative electrode was made of lithium-aluminum alloy in the form of foil. It produced an output voltage of 3.5 V, with the initial capacity being 250 mAh, owing to dissolution of lithium metal from the negative electrode and intercalation of lithium ions into the positive electrode during discharging in the initial stage. However, after 27 cycles of charging and discharging, it suffered short circuit because charging brought about deposition of lithium-aluminum compound and deposition of dendroid lithium metal. Thus the comparative sample is superior in initial output voltage but is poor in long-term stability and capacity.

### Example 11

FIG. 2 is a diagram showing a battery system equipped with the batteries according to the present invention. Each of the two batteries is a cylindrical lithium-aluminum secondary battery with 30 Ah, which and whose electrodes are 20 times as large as the one shown in Example 1. As shown in FIG. 2, the two lithium-aluminum secondary batteries 201a and 201b are connected in series in the battery system. The secondary batteries 201a and 201b may also be connected in parallel. The battery system will be designated as S1. The number of the batteries to be connected in series or in parallel may be properly varied according to the electric power required of the battery system S1.

Each of the lithium-aluminum secondary batteries 201a and 201b includes an identical an electrode group consisting of a positive electrode 207, a negative electrode 208, and separators 209. It is closed with an upper lid 203, which is provided with an external terminal 204 for the positive electrode and an external terminal 205 for the negative electrode. Each of the external terminals is isolated from the lid by an insulating seal 212 inserted between them, so that the external terminals are protected from short circuit. A battery container 202 is provided with a heater (not shown in FIG. 2) on its outside to warm the battery at the time of start-up. This heater is energized with an external source prior to start-up so that the battery temperature is raised up to a temperature (90° C., for instance) which is high enough for the electrolyte to melt. Each of the lithium-aluminum secondary batteries 201a and 201b shown in FIG. 2 is identical in internal structure with the one shown in FIG. 1, except that the lead wires 110 and 111 for the positive and negative electrodes are omitted.

The lithium-aluminum secondary battery 201a has the external terminal 205 for the negative electrode, which is connected through a power cable 213 to the input terminal for the negative electrode of a charging-discharging controller 216. The lithium-aluminum secondary battery 201a also has the external terminal 204 for the positive electrode, which is connected through the power cable 214 to the external terminal 205 for the negative electrode of the lithium-aluminum secondary battery 201b. The lithium-aluminum secondary battery 201b has the external terminal 204 for the positive electrode, which is connected through a power cable 215 to the input terminal for the positive electrode of the charging-discharging controller 216. The wiring in this manner permits the two lithium-aluminum secondary batteries 201a and 201b to be charged and discharged.

The charging-discharging controller 216 supplies and receives electric power to and from external equipment 219 through power cables 217 and 218. The external equipment 219 is comprised of an external source, regenerative motor, etc. to supply power to the charging-discharging controller 216, and such devices as inverter, converter, and load which are supplied with power from the battery system S1. The inverter and converter should be installed depending on whether the external equipment 219 works on AC or DC. The foregoing devices may be selected from any known ones.

The charging-discharging controller 216 is connected to an electric power generator 222 though power cables 220 and 221. The power generator 222 is so operated as to simulate a wind power generator as a renewable energy source. While the power generator 222 is generating power, the controller 216 shifts to the charging mode so as to supply power to the external equipment 219 and also supply excess power to the lithium-aluminum secondary batteries 201a and 212b for their charging. While the power generator 222 is generating power in an amount less than required of the external equipment 219, the controller 216 shifts to the discharging mode, thereby allowing the lithium-aluminum secondary batteries 201a and 212b to discharge electric power. The foregoing operation is carried out automatically by the program stored in the controller 216. Incidentally, the power generator 222 may be replaced by any other devices such as solar cell, geothermal generator, fuel cell, and gas turbine generator. The lithium-aluminum secondary batteries 201a and 201b are capable of storing as much electric power as necessary depending on the number of units connected in series or parallel.

The lithium-aluminum secondary batteries 201a and 201b were tested for performance at 90° C. by repeating charging and discharging with a constant current of 0.5 mA/cm², while setting the charging final voltage at 2.3 V and the discharging final voltage at 1.5 V. This test was carried out under the optimum conditions which depend on the type and amount of the materials constituting the lithium-aluminum secondary battery.

In the foregoing test, the lithium-aluminum secondary batteries 201a and 201b were charged first and then discharged, with the charging-discharging controller 216 shifted to the discharging mode. Usually, discharging is suspended when the voltage reaches a preset lower limit.

The above-mentioned battery system S1 was tested for performance in the following manner. At the time of charging, the lithium-aluminum secondary batteries 201a and 201b are supplied with electric power from the power generator 222 for regenerative energy through the charging-discharging controller 216. At the time of discharging, the lithium-aluminum secondary batteries 201a and 201b supply electric power to the external equipment 219 through the charging-discharging controller 216. This test showed that the lithium-aluminum secondary batteries 201a and 201b achieved 99.5 to 100% of the designed capacity of 30 Ah.

The battery system S1 further underwent the following pulse test when the depth of charge reached 50% (the state charged up to 15 Ah), in which the lithium-aluminum secondary batteries 201a and 201b were supplied repeatedly with a pulse current for 5 seconds in the charging direction and also with a pulse current for 5 seconds in the discharging direction. This test is intended to simulate the reception of power from the power generator 222 and the supply of power to the external device 219. The magnitude of the pulse current is 30 A in both directions. Subsequently, the lithium-aluminum secondary batteries 201a and 201b were charged at a current density of 0.5 mA/cm² until their voltage reached 2.3 V so that their remaining capacity of 15 Ah was filled. This charging step was followed by discharging at the same voltage as above until the battery voltage reached 1.5 V. The cycle of the charging-discharging test mentioned above was repeated 500 times. The results of the test indicate that the batteries retained 85 to 90% of their initial discharging capacity. This suggests that the performance of the battery system S1 remains nearly intact despite the input and output pulse currents applied to the batteries.

The embodiments mentioned above may be modified within the scope of the present invention by replacement of materials and parts with others. The scope of the present invention may be expanded by addition of any known technology or partial replacement with any known technology so long as it contains the secondary battery specified herein. With the external device 219 replaced by a driving unit such as electric motor, the battery according to the present invention will find use as a power source for electric cars, hybrid electric cars, conveyors, construction machines, nursing machines, light vehicles, electric tools, game machines, display units, television sets, cleaners, robots, portable information terminals, isolated islands, and space stations.

It is concluded from the foregoing that the present invention provides a new secondary battery which is greatly improved in output density, capacity, and safety.

### EXPLANATION OF REFERENCE CHARACTERS

101, 201a, 201b . . . Lithium-aluminum secondary battery
102, 202 . . . Battery container
103, 203 . . . Lid
104, 204 . . . External terminal for the positive electrode
105, 205 . . . External terminal for the negative electrode
106, 206 . . . Inlet for electrolytic solution
107, 207 . . . Positive electrode
108, 208 . . . Negative electrode
109, 209 . . . Separator
110 . . . Lead wire for the positive electrode
111 . . . Lead wire for the negative electrode
112, 212 . . . Insulating seal
213, 214, 215, 217, 218, 220, 221 . . . Power cable
216 . . . Charging-discharging controller
219 . . . External device
222 . . . Power generator for regenerative energy

What is claimed is:

1. A secondary battery capable of charging and discharging comprising:
a positive electrode;
a negative electrode; and
an electrolytic solution,
wherein the negative electrode permits aluminum to deposit thereon and the positive electrode permits lithium to be released therefrom at the time of discharging.

2. The secondary battery according to claim 1,
wherein the electrolytic solution contains a solvent, and lithium ions and aluminum ions dissolved in the solvent.

3. The secondary battery according to claim 1, having an output voltage no higher than 3.0 V as a single cell.

4. The secondary battery according to claim 1,
wherein the positive electrode includes a compound represented by a chemical formula LiNiₓMn₂₋ₓO₄ (where 0.4≦x≦0.6) as an active material.

5. The secondary battery according to claim 1,
wherein the negative electrode includes metallic aluminum.

6. The secondary battery according to claim 2,
wherein the electrolytic solution contains a compound represented by a chemical formula R¹—SO₂—R² (where R¹ and R² denote an alkyl group).

7. The secondary battery according to claim 2,
wherein the electrolytic solution further contains at least one of sodium salts and potassium salts.

8. The secondary battery according to claim 1,
wherein the discharging takes place at a temperature no lower than 90° C.

9. A secondary battery comprising:
a negative electrode including metallic aluminum;
a positive electrode including an active material that permits intercalation and deintercalation of lithium;
a separator; and
an electrolytic solution.

10. The secondary battery according to claim 9,
wherein the active material included in the positive electrode is represented by a chemical formula LiNiₓMn₂₋ₓO₄ (where 0.4≦x≦0.6) or a chemical formula LiNiₓQ_{y}Mn_{2-x-y}O₄ (where Q stands for at least one selected from the group consisting of the IIa, IIIa, and IVa groups of the periodic table, transition metals in the fourth period of the periodic table, Zn, Al, Ga, Si, and Ge; 0.4≦x≦0.6 and 0<y≦0.1).

11. The secondary battery according to claim 9,
wherein the electrolytic solution contains dimethyl sulfone, aluminum salt, and lithium salt, and
wherein the molar ratio of aluminum ions to dimethyl sulfone is no lower than 0.2, and the molar ratio of lithium ions to dimethyl sulfone is from 0.001 to 0.1.
